(19) United States
(12) Patent Application Publication
(10) Pub. No.: US 2017/0185672 A1
(43) Pub. Date: Jun. 29, 2017

(54) RANK AGGREGATION BASED ON A MARKOV MODEL

(71) Applicants: Xiaofeng YU, Beijing (CN); Junqing XIE, Beijing (CN); Hewlett Packard Enterprise Development LP, Houston, TX (US)

(72) Inventors: Xiaofeng Yu, Beijing (CN); Jun Qing Xie, Beijing (CN)

(21) Appl. No.: 15/325,060

(22) PCT Filed: Jul. 31, 2014
(86) PCT No.: PCT/CN2014/083379

§ 371 Date: Jan. 9, 2017

(51) Int. Cl. G06F 17/30; G06F 17/18

(52) U.S. Cl. CPC G06F 17/30687; G06F 17/30864; G06F 17/18

(57) ABSTRACT

Rank aggregation based on a Markov model is disclosed. One example is a system including a query processor, at least two information retrievers, a Markov model, and an evaluator. The query processor receives a query via a processing system. Each of the at least two information retrievers retrieves a plurality of document categories responsive to the query, each of the plurality of document categories being at least partially ranked. The Markov model generates a Markov process based on the at least partial rankings of the respective plurality of document categories. The evaluator determines, via the processing system, an aggregate ranking for the plurality of document categories, the aggregate ranking based on a probability distribution of the Markov process.

### BACKGROUND

Query categorization involves classifying web queries into pre-defined target categories. The target categories may be ranked. Query categorization is utilized to improve search relevance and online advertising.

### BRIEF DESCRIPTION OF THE DRAWINGS

FIG. 1 is a functional block diagram illustrating one example of a system for rank aggregation based on a Markov model.

FIG. 2 is a functional diagram illustrating another example of a system for rank aggregation based on a Markov model.

FIG. 3 is a block diagram illustrating one example of a processing system for implementing the system for rank aggregation based on a Markov model.

FIG. 4 is a block diagram illustrating one example of a computer readable medium for rank aggregation based on a Markov model.

FIG. 5 is a flow diagram illustrating one example of a method for rank aggregation based on a Markov model.

### DETAILED DESCRIPTION

As content in the World Wide Web (“WWW”) continues to grow at a rapid rate, web queries have become an important medium to understand a user's interests. Web queries may be diverse, and any meaningful response to a web query depends on a successful classification of the query into a specific taxonomy. Query categorization involves classifying web queries into pre-defined target categories. Web queries are generally short, with a small average word length. This makes them ambiguous. For example, “Andromeda” may mean the galaxy, or the Greek mythological hero. Also, web queries may be in constant flux, and may keep changing based on current events. Target categories may lack standard taxonomies and precise semantic descriptions. Query categorization is utilized to improve search relevance and online advertising.

Generally, query categorization is based on supervised machine learning approaches, labeled training data, and/or query logs. However, training data may become insufficient or obsolete as the web evolves. Obtaining high quality labeled training data may be expensive and time-consuming. Also, for example, many search engines and web applications may not have access to query logs.

As described herein, rank aggregation based on a Markov model is disclosed. A query may be expanded based on linguistic pre-processing, The expanded query may be provided to at least two information retrieval systems to retrieve ranked categories responsive to the query. A rank aggregation system based on a Markov model may be utilized to provide an aggregate ranking based on the respectively ranked categories from the at least two information retrieval systems. Such an approach provides a natural unsupervised framework based on information retrieval for query categorization.

The rank aggregation system may include a query processor, at least two information retrievers, a Markov model, and an evaluator. The query processor receives a query via a processing system. Each of the at least two information retrievers retrieves a plurality of document categories responsive to the query, each of the plurality of document categories being at least partially ranked. The Markov model generates a Markov process based on the at least partial rankings of the respective plurality of document categories. The evaluator determines, via the processing system, an aggregate ranking for the plurality of document categories, the aggregate ranking based on a probability distribution of the Markov process.

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

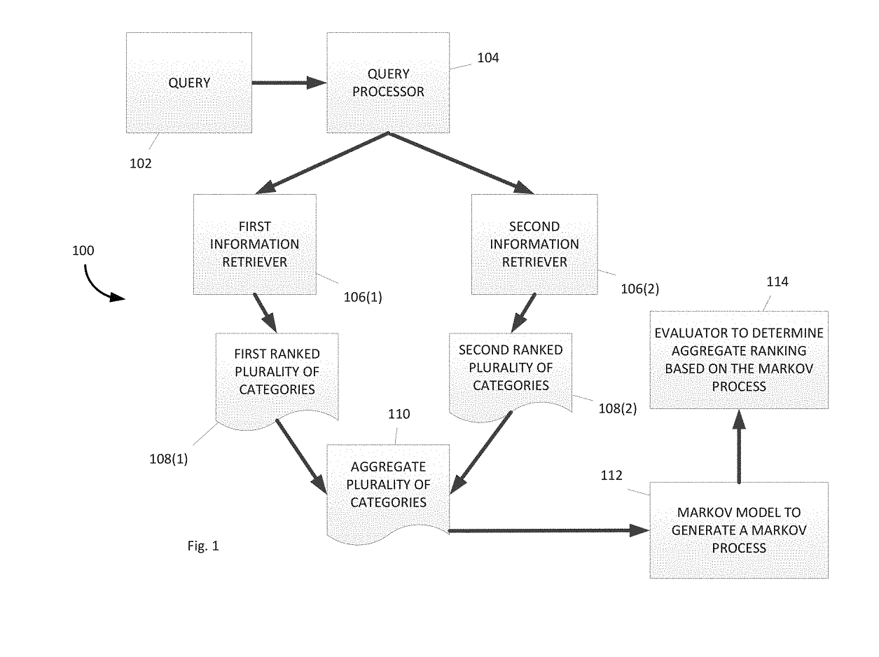

FIG. 1 is a functional block diagram illustrating one example of a system 100 for rank aggregation based on a Markov model. The system 100 receives a query via a query processor. The system 100 provides the query to a first information retriever 106(1) and a second information retriever 106(2). The system 100 retrieves a first ranked plurality of categories 108(1) and a second ranked plurality of categories 108(2) from the first information retriever 106(1) and the second information retriever 106(2), respectively. An aggregate plurality of categories 110 is formed from the first ranked plurality of categories 108(1) and the second ranked plurality of categories 108(2). The system 100 utilizes a Markov model 112 to generate a Markov process, and determines an aggregate ranking based on the Markov process.

System 100 receives a query 102 via a query processor 104. A query is a request for information about something. A web query is a query that may submit the request for information to the web. For example, a user may submit a web query by typing a query into a search field provided by a web search engine. In one example, the query processor 104 may modify the query based on linguistic preprocessing. As described herein, queries are generally short, and may not accurately reflect their concepts and intents. To improve the search result retrieval process, the query may be expanded to match additional relevant documents. Linguistic preprocessing may include stemming (e.g. finding all morphological forms of the query), abbreviation extension (e.g. WWW may be extended to World Wide Web), stop-word filtering, misspelled word correction, part-of-speech (“POS”) tagging, name entity recognition (“NER”), and so forth.

In one example, a hybrid and/or effective query expansion technique may be utilized, that includes global information as well semantic information. The global information may be retrieved from the WWW by providing the query to a publicly available web search engine. In one example, key terms may be extracted from a predetermined number of top returned titles and snippets, and the extracted key terms may be used to represent essential concepts and/or intents of the query. The semantic information may be based on a retrieval of synonyms from a semantic lexical database. For example, the query may be associated with a noun, verb, noun phrase and/or verb phrase.

System 100 includes at least two information retrievers 106, each information retriever to retrieve a plurality of document categories responsive to the query, each of the plurality of document categories being at least partially ranked. A first information retriever 106(1) and a second information retriever 106(2) may be included. In one example, the at least two information retrieval systems may be selected from the group consisting of a bag of words retrieval system, a latent semantic indexing system, a language model system, and a text categorizer system.

In one example, the at least two information retrievers 106 may include a bag of words retrieval system that ranks a set of documents according to their relevance to the query. The bag of words retrieval system comprises a family of scoring functions, with potentially different components and parameters. A query q may contain keywords q₁, q₂, . . . qₙ. A bag of words probability score of a document may be determined as:

$$P ( d , q ) = {\sum }_{i = 1}^{n} idf ( {q}_{i} ) \cdot \frac{tf ( {q}_{i} , d ) \cdot ( {k}_{1} + 1 )}{{k}_{1} \cdot ( ( 1 - b ) + b \cdot \frac{\vert d \vert}{avg ( dl )} ) + tf ( {q}_{i} , d )} , \qquad ( Eq . 1 )$$

where t ƒ(qᵢ, d) is qᵢ's term frequency in the document d, |d| is the length of the document d in words, avg(dl) is the average document length in the dataset, k₁ and b are free parameters. In one example, k₁ may be chosen from the interval [1.2, 2.0] and b=0.75. The term idƒ(qᵢ) is the inverse document frequency weight of qᵢ, and it may be generally computed as:

$$idf ( {q}_{i} ) = log \frac{N - n ( {q}_{i} ) + 0.5}{n ( {q}_{i} ) + 0.5} , \qquad ( Eq . 2 )$$

where N is the total number of documents and n(qᵢ) is the number of documents containing qᵢ.

In one example, the at least two information retrievers 106 may include a language model (“LM”) system. A language model M_{d} may be constructed from each document d in a dataset. The documents may be ranked based on the query, for example, by determining a conditional probability P(d|q) of the document d given the query q. This conditional probability may be indicative of a likelihood that document d is relevant to the query q. An application of Bayes Rule provides:

$$P ( d \vert q ) = \frac{P ( q \vert d ) \cdot P ( d )}{P ( q )} \qquad ( Eq . 3 )$$

where P(q) is the same for all documents, and may therefore be removed from the equation. Likewise, the prior probability of a document P(d) is often treated as uniform across all d and may also be ignored. Accordingly, the documents may be ranked by P(q|d). In an LM system, the documents are ranked by the probability that the query may be observed as a random sample in the respective document model M_{d}. In one example, a multinomial unigram language model may be utilized, where the documents are classes, and each class is treated as a language. In this instance, we obtain:

P(q|M_{d})=K_{q}Π_{t∈V}P(t|M_{d})^{tƒ}^{_{t,d}} (Eq. 4)

where K_{q} is the multinomial coefficient for the query q, and may be ignored. In the LM system, the generation of queries may be treated as a random process. For each document, an LM may be inferred, the probability P(q|M_{d}_{ᵢ}) of generating the query according to each document model may be estimated, and the documents may be ranked based on such probabilities.

In one example, the at least two information retrievers 106 may include a latent semantic indexing system, for example, a probabilistic latent semantic indexing system (“PLSA”). PLSA is generally based on a combined decomposition derived from a latent class model. Given observations in the form of co-occurrences (q, d) of query q and document d, PLSA may model the probability of each co-occurrence as a combination of conditionally independent multinomial distributions:

P(q,d)=Σ_{c}P(c)P(d|c)P(q|c)=P(d)Σ_{c}P(c|d)P(q|c) (Eq. 5)

As described, the first formulation is the symmetric formulation, where q and d are both generated from a latent class c in similar ways by utilizing conditional probabilities P(d|c) and P(q|c). The second formulation is an asymmetric formulation, where for each document d, a latent class is selected conditionally to the document according to P(c|d), and a query is generated from that class according to P(q|c). The number of parameters in the PLSA formulation may be equal to cd+qc, and these parameters may be efficiently learned using a standard learning model.

System 100 may provide a first ranked plurality of categories 108(1) from the first information retriever 106(1), and a second ranked plurality of categories 108(2) from the second information retriever 106(2). As described herein, each of the plurality of document categories are at least partially ranked. In one example, the entire list of categories may be ranked. In one example, the list of categories may be a top d list, where all d ranked categories are above all unranked categories. A partially ranked list and/or a top d list may be converted to a fully ranked list by providing the same ranking to all the unranked categories.

The system 100 may aggregate the two ranked categories to form an aggregate plurality of categories 110. In one example, system 100 may retrieve a plurality of documents from the at least two information retrieval systems 106, each document of the plurality of documents associated with each category of the respective plurality of document categories. For example, system 100 may retrieve a collection of documents O^{q}={d₁^{q}, d₂^{q}, . . . , dᵣ^{q}} for the query q, where each document d₁^{q} has a category cᵢ. In one example, system 100 may provide three lists of at least partially ranked categories [symbol] ₁^{q}={c₁^{q}, c₂^{q}, . . . , cₗ^{q}}₁, [symbol] ₂^{q}={c₁^{q}, c₂^{q}, . . . , cₘ^{q}}₂, and [symbol] ₃^{q}={c₁^{q}, c₂^{q}, . . . , cₙ^{q}}₃ obtained from three information retrievers IR₁, IR₂, and IR₃. In each of the three lists, a category cᵢ^{q} is more

System 100 includes a Markov model 112 to generate a Markov process based on the at least partial rankings of the respective plurality of document categories. In one example, Markov model 112 generates the Markov process to provide an unsupervised, computationally efficient rank aggregation of the categories to aggregate and optimize the at least partially ranked categories obtained from the three information retrievers IR₁, IR₂, and IR₃. Rank aggregation may be formulated as a graph problem. The Markov process may be defined by a set of n states [symbol] and an n×n non-negative, stochastic transition matrix [symbol] defining transition probabilities tᵢⱼ to transition from state i to state j, where for each given state i, we have Σᵢⱼtᵢⱼ=1. The states [symbol] may be the category candidates to be ranked, comprising the aggregate list of categories from [symbol] ₁^{q}, [symbol] ₂¹, and [symbol] ₃^{q}. The transitions tᵢⱼ may depend on the individual partial rankings in the lists of categories.

In one example, the matrix [symbol] may be defined based on transitions such as: for a given category candidate cₐ, (1) another category c_{b} may be selected uniformly from among all categories that are ranked at least as high as Cₐ; (2) a category list [symbol] ᵢ^{q} may be selected uniformly at random, and then another category c_{b} may be selected uniformly from among all categories in [symbol] ᵢ^{q} that are ranked at least as high as Cₐ; (3) a category list [symbol] ᵢ^{q} may be selected uniformly at random, and then another category c_{b} may be selected uniformly from among all categories in [symbol] ᵢ^{q}. If c_{b} is ranked higher than cₐ in [symbol] ᵢ^{q}, then the Markov process transits to c_{b}, otherwise the Markov process stays at cₐ; and (4) choose a category c_{b} uniformly at random, and if c_{b} is ranked higher than cₐ in most of the lists of categories, then the Markov process transits to c_{b}, else it stays at cₐ. Such transition rules may be applied iteratively to each category in the aggregate plurality of categories 110.

System 100 includes an evaluator 114 to determine, via the processing system, an aggregate ranking for the plurality of document categories, the aggregate ranking being based on a probability distribution of the Markov process. In one example, the Markov process provides a unique stationary distribution v=<v₁, v₂, . . . , vₙ>^{T} such that [symbol] v=v. The vector v provides a list of probabilities which may be ranked in decreasing order as {vₖ_{₁}, vₖ_{₂}, . . . vₖ_{ₙ}}. Based on such ranking, the corresponding categories from the aggregate plurality of categories 110 may be ranked as {cₖ_{₁}, cₖ_{₂}, . . . , cₖ_{ₙ}}.

In one example, the query processor 104 may provide a list of documents responsive to the query, the list of documents selected from the plurality of documents, and the list ranked based on the aggregate ranking. For example, a list of documents d₁, d₂, . . . , dₙ may be retrieved from each of the categories c₁, c₂, . . . , cₙ. Based on the ranking of the categories as cₖ_{₁}, cₖ_{₂}, . . . , cₖ_{ₙ}, we may derive a corresponding ranking of respective documents dₖ_{₁}, dₖ_{₂}, . . . , dₖ_{ₙ}, and the query processor 104 may provide such a ranked list of documents in response to the query q.

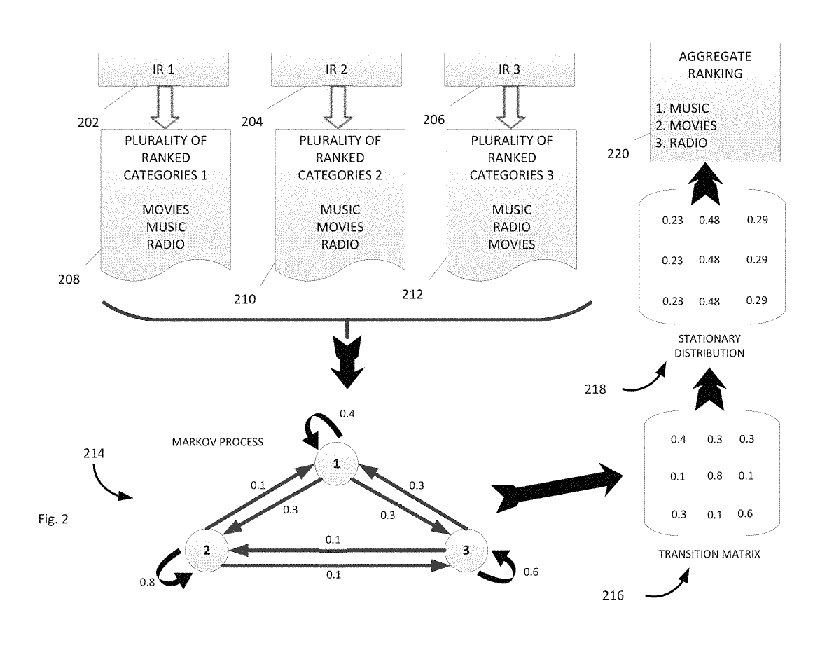

FIG. 2 is a functional diagram illustrating another example of a system for rank aggregation based on a Markov model. A first information retriever IR₁ 202 provides a first plurality of ranked categories 208. The example categories “Movies”, “Music”, and “Radio” are ranked in descending order. A second information retriever IR₂ 204 provides a second plurality of ranked categories 210. The example categories “Music”, “Movies”, and “Radio” are ranked in descending order. A third information retriever IR₃ 206 provides a third plurality of ranked categories 212. The example categories “Music”, “Radio”, and “Movies” are ranked in descending order. A Markov Process 214 is generated based on the rankings. The three states are labeled “1”, “2”, and “3”, and correspond to each of the ranked categories. State “1” represents the category “Radio”; state “2” represents the category “Music”; and state “3” represents the category “Movies”. The arrows represent the transitions from one state to another, and associated transition probabilities. For example, the arrow from state “1” to itself has a transition probability of 0.4. The arrow from state “1” to state “2” has a transition probability of 0.3, whereas the arrow from state “2” to state “1” has a transition probability of 0.1.

A transition matrix 216 may be generated based on the transition probabilities. The if^{th} entry in the transition matrix 216 represents the transition probability from state i to state j. For example, entry “11” corresponds to the transition probability 0.4 to transit from state 1 to itself. Also, for example, entry “12” corresponds to the transition probability 0.3 to transit from state 1 to state 2.

A stationary distribution 218 may be obtained for the transition matrix 216. The vector v=<0.23, 0.48, 0.29>^{T} corresponds to the stationary distribution. Based on the vector v, state “2” corresponding to “Music” has the highest probability of 0.48, followed by state “3” corresponding to “Movies” with a probability of 0.29, and state “1” corresponding to “Radio” with a probability of 0.23. Accordingly, an aggregate ranking 220 may be derived, where the categories may be ranked in descending order as “Music”, “Movies”, and “Radio”.

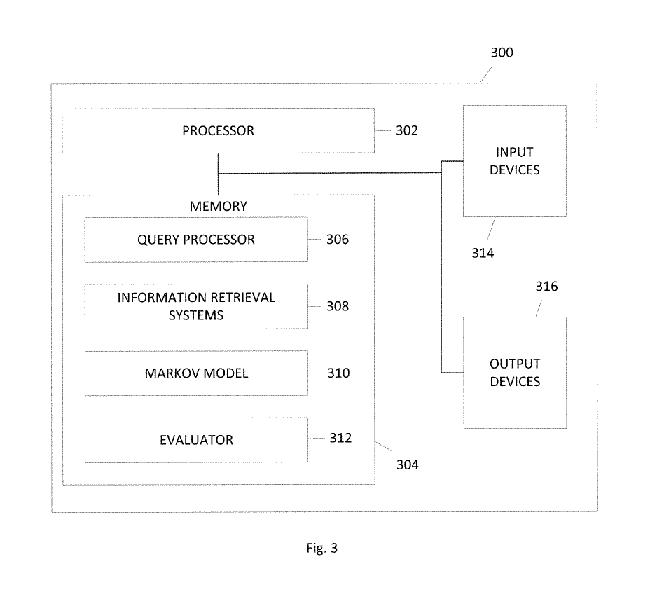

FIG. 3 is a block diagram illustrating one example of a processing system 300 for implementing the system 100 for rank aggregation based on a Markov model. Processing system 300 includes a processor 302, a memory 304, input devices 314, and output devices 316. Processor 302, memory 304, input devices 314, and output devices 316 are coupled to each other through a communication link (e.g., a bus).

Processor 302 includes a Central Processing Unit (CPU) or another suitable processor or processors. In one example, memory 304 stores machine readable instructions executed by processor 302 for operating processing system 300. Memory 304 includes any suitable combination of volatile and/or non-volatile memory, such as combinations of Random Access Memory (RAM), Read-Only Memory (ROM), flash memory, and/or other suitable memory.

Memory 304 stores instructions to be executed by processor 302 including instructions for a query processor 306, at least two information retrieval systems 308, a Markov model 310, and an evaluator 312. In one example, query processor 306, at least two information retrieval systems 308, Markov model 310, and evaluator 312, include query processor 104, first information retriever 106(1), second information retriever 106(2), Markov Model 112, and evaluator 114, respectively, as previously described and illustrated with reference to FIG. 1.

In one example, processor 302 executes instructions of query processor 306 to receive a query via a processing system. In one example, processor 302 executes instructions of query processor 306 to modify the query based on linguistic preprocessing. In one example, the linguistic preprocessing may be selected from the group consisting of stemming, abbreviation extension, stop-word filtering, misspelled word correction, part-of-speech tagging, named entity recognition, and query expansion. In one example, processor 302 executes instructions of query processor 306 to provide the modified query to the at least two information retrieval systems. In one example, processor 302 executes instructions of query processor 306 to provide a list of documents responsive to the query, the list of documents being selected from the plurality of documents, and the list ranked based on the aggregate ranking as described herein.

Processor 302 executes instructions of information retrieval systems 308 to retrieve a plurality of document categories responsive to the query, each of the plurality of document categories being at least partially ranked. In one example, the at least two information retrieval systems retrieve a plurality of documents, each document of the plurality of documents associated with each category of the respective plurality of document categories. In one example, the at least two information retrieval systems may be selected from the group consisting of a bag of words retrieval system, a latent semantic indexing system, a language model system, and a text categorizer system. Additional and/or alternative information retrieval systems may be utilized.

Processor 302 executes instructions of a Markov Model 310 to generate a Markov process based on the at least partial rankings of the respective plurality of document categories. Processor 302 executes instructions of an evaluator 312 to determine, via the processing system, an aggregate ranking for the plurality of document categories, the aggregate ranking based on a probability distribution of the Markov process.

Input devices 314 may include a keyboard, mouse, data ports, and/or other suitable devices for inputting information into processing system 300. In one example, input devices 314 are used to input a query term. Output devices 316 may include a monitor, speakers, data ports, and/or other suitable devices for outputting information from processing system 300. In one example, output devices 316 are used to provide responses to the query term. For example, output devices 316 may provide the list of documents responsive to the query.

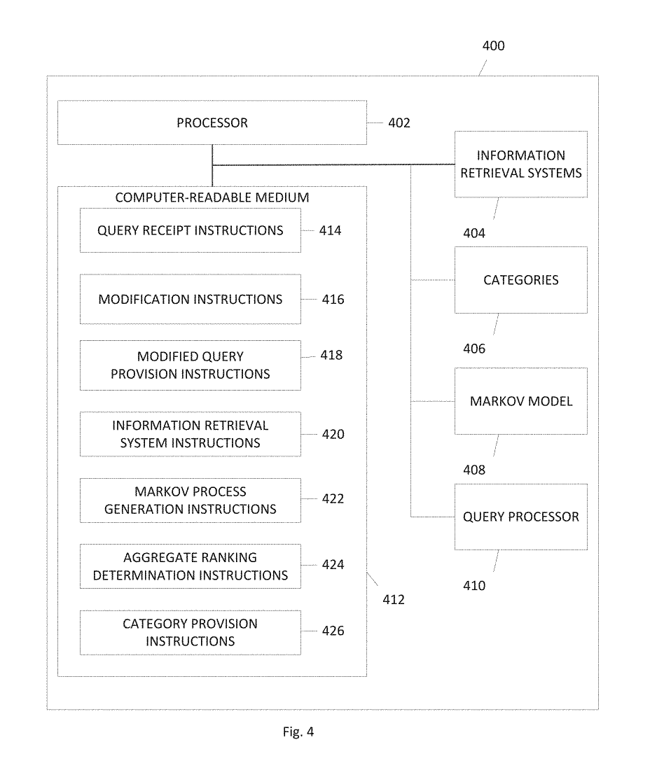

FIG. 4 is a block diagram illustrating one example of a computer readable medium for rank aggregation based on a Markov model. Processing system 400 includes a processor 402, a computer readable medium 412, at least two information retrieval systems 404, categories 406, a Markov Model 408, and a Query Processor 410. Processor 402, computer readable medium 412, the at least two information retrieval systems 404, the categories 406, the Markov Model 408, and the Query Processor 410 are coupled to each other through communication link (e.g., a bus).

Processor 402 executes instructions included in the computer readable medium 412. Computer readable medium 412 includes query receipt instructions 414 of the query processor 410 to receive a query. Computer readable medium 412 includes modification instructions 416 of the query processor 410 to modify the query based on linguistic preprocessing. Computer readable medium 412 includes modified query provision instructions 418 of the query processor 410 to provide the modified query to at least two information retrieval systems 404.

Computer readable medium 412 includes information retrieval system instructions 420 of the at least two information retrieval systems 404 to retrieve, from each of the at least two information retrieval systems 404, a plurality of document categories responsive to the modified query, each of the plurality of document categories being at least partially ranked. The document categories may be retrieved from a publicly available catalog of categories 406. In one example, computer readable medium 412 includes information retrieval system instructions 420 of the at least two information retrieval systems 404 to retrieve a plurality of documents, each document of the plurality of documents associated with each category of the respective plurality of document categories.

Computer readable medium 412 includes Markov process generation instructions 422 of a Markov Model 408 to generate a Markov process based on the at least partial rankings of the respective plurality of document categories. Computer readable medium 412 includes aggregate ranking determination instructions 424 of an evaluator to determine an aggregate ranking for the plurality of document categories, the aggregate ranking based on a probability distribution of the Markov process. Computer readable medium 412 includes category provision instructions 426 to provide, in response to the query, a list of document categories based on the aggregate ranking for the plurality of document categories. In one example, computer readable medium 412 includes category provision instructions 426 to provide a list of documents responsive to the web query, the list of documents selected from the plurality of documents, and the list ranked based on the aggregate ranking.

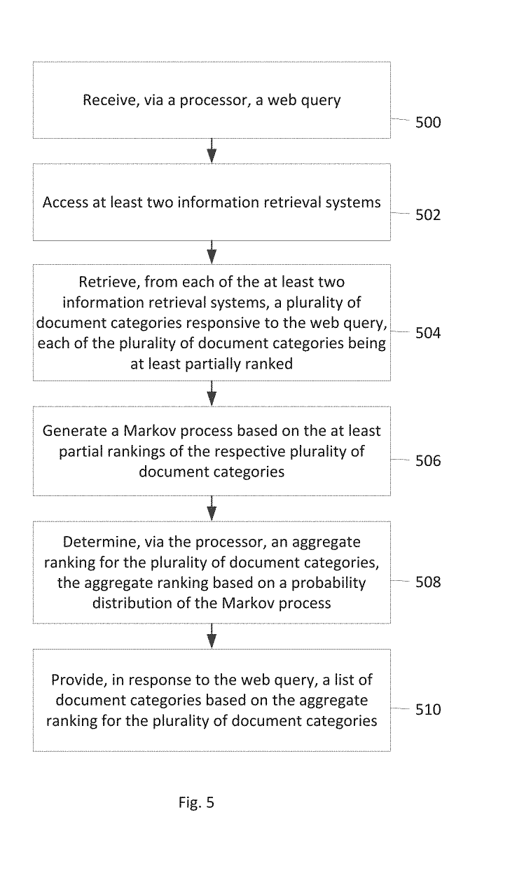

FIG. 5 is a flow diagram illustrating one example of a method for rank aggregation based on a Markov model. At 500, a web query is received via a processor. At 502, at least two information retrieval systems are accessed. At 504, from each of the at least two information retrieval systems, a plurality of document categories responsive to the web query are retrieved, each of the plurality of document categories being at least partially ranked. At 506, a Markov process is generated based on the at least partial rankings of the respective plurality of document categories. At 508, an aggregate ranking is determined, via the processor, for the plurality of document categories, the aggregate ranking based on a probability distribution of the Markov process. At 510, a list of document categories is provided in response to the web query, based on the aggregate ranking for the plurality of document categories.

In one example, modifying the web query may include randomly permuting the components of the concatenated query term.

In one example, the associated set of keys may include linguistic preprocessing, and providing the modified web query to the at least two information retrieval systems. In one example, the linguistic preprocessing is selected from the group consisting of stemming, abbreviation extension, stop-word filtering, misspelled word correction, part-of-speech tagging, named entity recognition, and query expansion.

In one example, the at least two information retrieval systems may be selected from the group consisting of a bag of words retrieval system, a latent semantic indexing system, a language model system, and a text categorizer system.

In one example, the at least two information retrieval systems may retrieve a plurality of documents, each document of the plurality of documents associated with each category of the respective plurality of document categories. In one example, the method may include providing a list of documents responsive to the web query, the list of documents selected from the plurality of documents, and the list ranked based on the aggregate ranking.

Examples of the disclosure provide an unsupervised, computationally efficient rank aggregation of categories to aggregate and optimize at least partially ranked categories obtained from at least two information retrieval systems. A consensus aggregate ranking may be determined based on different category rankings to minimize potential disagreements between the different category rankings from the at least two information retrieval systems.

Although specific examples have been illustrated and described herein, the examples illustrate applications to any information retrieval systems. Accordingly, there may be a variety of alternate and/or equivalent implementations that may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a query processor to receive a query via a processing system;
at least two information retrievers, each information retriever to retrieve a plurality of document categories responsive to the query, each of the plurality of document categories being at least partially ranked;
a Markov model to generate a Markov process based on the at least partial rankings of the respective plurality of document categories; and
an evaluator to determine, via the processing system, an aggregate ranking for the plurality of document categories, the aggregate ranking based on a probability distribution of the Markov process.

2. The system of claim 1, wherein the query processor further:
modifies the query based on linguistic preprocessing; and
provides the modified query to the at least two information retrieval systems.

3. The system of claim 2, wherein the linguistic preprocessing is selected from the group consisting of stemming, abbreviation extension, stop-word filtering, misspelled word correction, part-of-speech tagging, named entity recognition, and query expansion.

4. The system of claim 1, wherein the at least two information retrieval systems are selected from the group consisting of a bag of words retrieval system, a latent semantic indexing system, a language model system, and a text categorizer system.

5. The system of claim 1, wherein the at least two information retrieval systems retrieve a plurality of documents, each document of the plurality of documents associated with each category of the respective plurality of document categories.

6. The system of claim 5, wherein the query processor provides a list of documents responsive to the query, the list of documents selected from the plurality of documents, and the list ranked based on the aggregate ranking.

7. A method for web query categorization, the method comprising:
receiving, via a processor, a web query;
accessing at least two information retrieval systems;
retrieving, from each of the at least two information retrieval systems, a plurality of document categories responsive to the web query, each of the plurality of document categories being at least partially ranked;
generating a Markov process based on the at least partial rankings of the respective plurality of document categories;
determining, via the processor, an aggregate ranking for the plurality of document categories, the aggregate ranking based on a probability distribution of the Markov process; and
providing, in response to the web query, a list of document categories based on the aggregate ranking for the plurality of document categories.

8. The method of claim 7, further comprising:
modifying the web query based on linguistic preprocessing; and
providing the modified web query to the at least two information retrieval systems.

9. The method of claim 8, wherein the linguistic preprocessing is selected from the group consisting of stemming, abbreviation extension, stop-word filtering, misspelled word correction, part-of-speech tagging, named entity recognition, and query expansion.

10. The method of claim 7, wherein the at least two information retrieval systems are selected from the group consisting of a bag of words retrieval system, a latent semantic indexing system, a language model system, and a text categorizer system.

11. The method of claim 7, wherein the at least two information retrieval systems retrieve a plurality of documents, each document of the plurality of documents associated with each category of the respective plurality of document categories.

12. The method of claim 11, further comprising providing a list of documents responsive to the web query, the list of documents selected from the plurality of documents, and the list ranked based on the aggregate ranking.

13. A non-transitory computer readable medium comprising executable instructions to:
receive, via a processor, a query;
modify the query based on linguistic preprocessing;
provide the modified query to at least two information retrieval systems;
retrieve, from each of the at least two information retrieval systems, a plurality of document categories responsive to the modified query, each of the plurality of document categories being at least partially ranked;
generate a Markov process based on the at least partial rankings of the respective plurality of document categories;
determine, via the processor, an aggregate ranking for the plurality of document categories, the aggregate ranking based on a probability distribution of the Markov process; and
provide, in response to the query, a list of document categories based on the aggregate ranking for the plurality of document categories.

14. The non-transitory computer readable medium of claim 13, further including instructions to retrieve a plurality of documents, each document of the plurality of documents associated with each category of the respective plurality of document categories.

15. The non-transitory computer readable medium of claim 14, further including instructions to provide a list of documents responsive to the web query, the list of documents selected from the plurality of documents, and the list ranked based on the aggregate ranking.
